(19) United States
(12) Patent Application Publication
(10) Pub. No.: US 2008/0038102 A1
(43) Pub. Date: Feb. 14, 2008

(54) TRASH REMOVAL SYSTEM

(76) Inventors: Michael James Murphy, East Greenwich, RI (US); Lynn Alison Murphy, East Greenwich, RI (US)

Correspondence Address: FISH & RICHARDSON PC, P.O. BOX 1022, MINNEAPOLIS, MN, 55440-1022, US

(21) Appl. No.: 11/463,800

(22) Filed: Aug. 10, 2006

(51) Int. Cl. B65G 65/04

(52) U.S. Cl. 414/403

(57) ABSTRACT

A waste hauling system comprises a receptacle for holding waste, a drive system including a wheel for moving the receptacle and a drive motor mechanically coupled to the wheel, a power source configured to drive the motor, a sensor for receiving a signal for operating the drive system, and a remote device including a transmitter for sending the signal received by the sensor.

### TECHNICAL FIELD

The invention relates to trash removal systems.

### BACKGROUND

Garbage, trash, and other waste is typically collected and stored in garbage barrels. The garbage barrels are preferably stored at locations convenient to a home or office, but not so close as to be subjected to undesirable pests (e.g., flies) and odors. The garbage barrels used for households are often in the form of wheeled bins that are stored conveniently close by in a garage or shed but not so close as to be accessible to wildlife (e.g., mice, rats, skunks, raccoons) and pests (e.g., flies). If the household is part of community in which the municipality is responsible for collecting the trash (e.g., once per week), the household is generally responsible for moving the garbage barrels to a location (e.g., end of a driveway or along a curbed street) convenient for the trash collectors to empty the garbage barrels into a garbage truck where the trash is then taken to landfill or dump.

Some garbage trucks are equipped with a mechanical arm that grasps the garbage barrels and empties it into the truck.

### SUMMARY

In a general aspect of the invention, a waste hauling system comprises a receptacle for holding waste, a drive system including a wheel for moving the receptacle and a drive motor mechanically coupled to the wheel, a power source configured to drive the motor, a sensor for receiving a signal for operating the drive system, and a remote device including a transmitter for sending the signal received by the sensor.

Embodiments of this aspect of the invention may include one or more of the following features:

The drive system may include more than one wheel. For example, a first and a second wheel may be spaced apart, for example along an axle. The drive system may further include a plurality of drive motors, with a first and a second of the drive motors coupled to the first and second wheels, respectively. The first and second drive motors may be operable at different rotational speeds to turn the drive system. In these cases, the waste hauling system may further include a front wheel that moves freely in a motion and a turning direction. As another example, the waste hauling system may include a front axle coupled to at least one of the wheels and a turning motor operable to turn the common front axle. In this example, the turning motor may be a servo motor.

The drive system may include a controller operable to control the rotational speed of the drive motor. The drive system may include a rolling track driven by the wheel. A carriage may be coupled to the drive system and configured to support the receptacle. In some cases, the receptacle may be detachable from the carriage. The power source configured to power the drive motor may include at least one battery.

The remote device may be a hand-held device. The remote device may include a joystick for receiving instructions from a user. The remote device may include a keypad for receiving instructions from a user. The remote device may include a microcontroller operable to convert instructions from a user into the signal sent to the sensor. The signal sent by the remote device to the sensor may be a wireless signal (e.g., radio frequency (RF) signal.

The transmitter of the remote device may be a wire positioned along a desired path of the waste hauling system. In this embodiment, the waste hauling system has a pre-established path and control (e.g., steering) by the user is not necessary.

In another aspect of the invention, a method of transporting waste held in a receptacle includes remotely generating a command for moving a drive system coupled to the receptacle, wirelessly transmitting the command to the drive system, and activating a drive motor to move the drive system according to the command.

Embodiments of this aspect of the invention may include one or more of the following features: The drive system may be turned by controlling the rotational speed of each of a plurality of drive motors. The drive system may be turned by activating a servo motor connected to a common front axle connected to at least one of a plurality of wheels.

Among other advantages, a system and method as described allows a user to transport waste without handling the receptacle containing the waste. Thus, the user can control the receptacle while remaining safely indoors, particularly advantageous in inclement weather. In a typical scenario, the user could open the garage door using the same or different remote control device used for controlling the waste hauling system. The user would then activate waste hauling system to exit the garage and travel to the point at which trash collectors expect the trash receptacle to be. Once the trash receptacle is emptied, the user can control the waste hauling system to return to the garage.

The user can also avoid the risk of injury associated with physically moving the waste receptacle. In particular, a user can avoid strain injuries that can result from physically moving a waste receptacle laden with heavy waste. Furthermore, the system and method as described may minimize inadvertent waste spills that can occur when a user physically moves a waste receptacle.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates a waste hauling system.

FIG. 2 is a bottom view of one embodiment of a drive system, for use with the waste hauling system of FIG. 1.

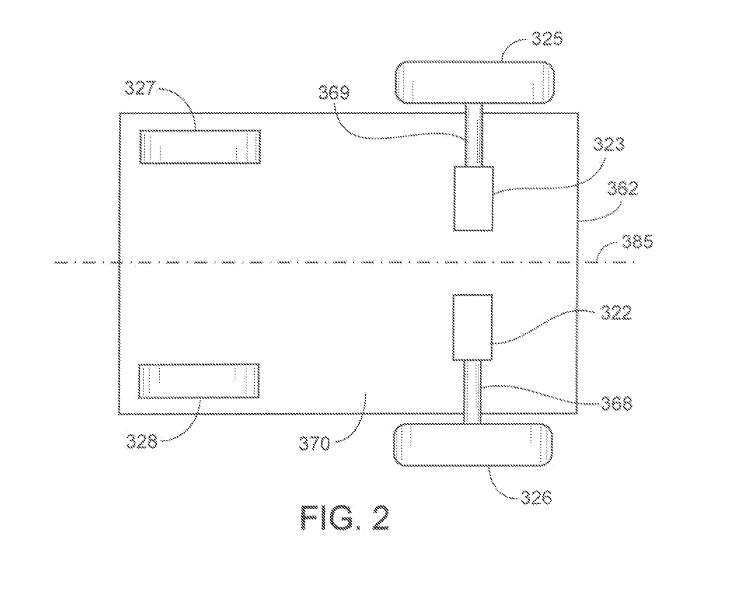

FIG. 3A is a side view of another embodiment of a drive system.

FIG. 3B is a bottom view of the drive system of FIG. 3A.

FIG. 4 is a bottom view of another embodiment of the drive system.

FIG. 5 is a flowchart diagram of the operation of the system of FIG. 3A and 3B.

### DETAILED DESCRIPTION

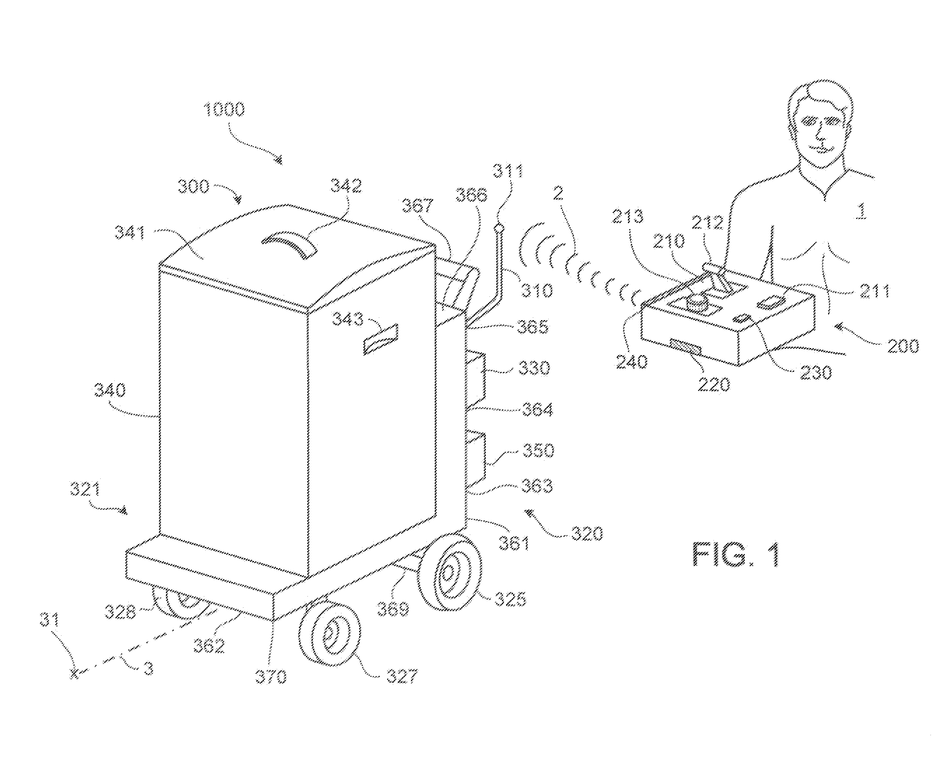

Referring to FIG. 1, a waste hauling system 1000 includes a waste transporter 300 and a remote device 200. In operation, waste transporter 300 receives electrical or optical signals 2 from remote device 200 operated by a user 1. Signals 2 include commands to control the motion of waste transporter 300 to a desired location 31. Thus, by using remote device 200 to control the movement of waste transporter 300, user 1 is not required to transport the waste in a trash barrel or otherwise to the desired location 31. Rather, the user can remain indoors, protected from the cold, wind and rain, and transport the waste transporter using the remote device.

As will be discussed in further detail below, waste transporter 300 includes a receptacle 340 for containing waste. As described below, receptacle 340 is preferably removable from waste transporter 300 to allow trash collectors to more easily lift the receptacle without having to lift the transporter when emptying the trash into, for example, a garbage truck. Receptacle 340 also includes a lid 341 to enclose the waste in the receptacle. Waste transporter 300 also includes a drive system 320 for moving the waste transporter and a power supply 350 for powering the drive system. Waste transporter 300 further includes a sensor 310 for receiving signals 2 for operating drive system 320. Waste transporter 300 includes a controller 330 operable to process signals 2 into control commands for specific elements of drive system 320.

As will be discussed in further detail below, remote device 200 includes a transmitter 240 for sending signals 2 to waste transporter 300. In this embodiment, remote device 200 includes a user interface 210 to allow user 1 to input control commands to be communicated to transmitter 240 and subsequently included in signals 2. Remote device 200 includes a power supply 220 (e.g., a battery) for powering the remote device.

As shown in FIG. 1, user 1 enters commands to remote device 200 through an interface 210. Interface 210 includes a motion controller 212 and a turning controller 213 to receive motion (i.e., forward and reverse) and turning instructions, respectively. In some embodiments, interface 210 includes a keypad to accept input from user 1. In other embodiments, interface 210 includes a joystick that allows user 1 to input motion and turning instructions.

In the embodiment shown in FIG. 1, remote device 200 is a wireless device to enhance the portability of remote device 200. Transmitter 240 may broadcast signals 2 using a wireless transmission to allow out-of-sight communication between remote device 200 and waste transporter 300. For example, transmitter 240 may broadcast signals 2 in the form of a radio frequency (RF) signal. In other embodiments, transmitter 240 may broadcast signals 2 in the form of infrared light generated by one or more light-emitting diodes (LEDs).

Remote device 200 includes a microcontroller (not shown) that is connected to remote power source 220 and interface 210. In the embodiment shown in FIG. 1, user 1 inputs commands through interface 210 and the instructions are passed to the microcontroller for controlling transmitter 240.

Waste transporter 300 also includes a power source 350, electrically connected to drive system 320. In some embodiments, power source 350 may include at least one battery. For example, the battery may be a nickel-cadmium (Ni Cd) or a lithium ion (Li ion) battery. In other embodiments, power source 350 may include AC power. For example, power source 350 may include an extension cord that allows waste transporter 300 to remain connected to grid power while waste transporter 300 is in operation.

Sensor 310 receives signals 2 broadcast by transmitter 240 on remote device 200. Sensor 310 is powered by power source 350. As shown in FIG. 1, sensor 310 includes an antenna 311 for receiving signals 2. In other embodiments, sensor 310 includes more than one antenna positioned on waste transporter 300 to improve reception of signals 2.

In some embodiments, receptacle 340 is releasably attached to drive system 320 (e.g. using interference fit, magnets, clips, gravity and friction, or straps). These embodiments may allow receptacle 340 to be removed from drive system 320 to protect the drive system from damage during waste collection and/or to facilitate emptying the receptacle. These embodiments may also allow a single drive system 320 to accommodate various shapes, sizes, and numbers of receptacles (e.g., commercially available garbage cans). In other embodiments, receptacle 340 is permanently fixed to drive system 320 (e.g., welded) to minimize inadvertent spilling of waste from the receptacle.

Drive system 320 includes a carriage 360 to hold receptacle 340 in place while waste transporter 300 is in motion. Carriage 360 may be in the form of modular components to reduce manufacturing costs and facilitate repair of waste transporter 300. As shown in FIG. 1, carriage 360 includes a power port 363 and a controller port 364, to allow power source 350 and controller 330, respectively, to be connected to drive system 320 (e.g., using a plug connection). Power port 363 and controller port 364 are positioned along back panel 361 to facilitate accessibility and to shield the components from debris. Carriage 360 also includes a sensor port 365 positioned along the top portion 366 of back panel 361 to facilitate optimal reception of signals 2.

Referring again to FIG. 1 and to 2, drive system 320 includes drive motors 322, 323. Drive motors 322, 323 are coupled to drive axles 368, 369. In this embodiment, drive motors 322, 323 are parallel shaft motors to facilitate mechanical coupling of the drive motors to drive axles 368, 369. In this embodiment, drive motors 322, 323 may operate at variable speeds. Thus, as will be discussed in further detail below, one drive motor may be driven at a greater speed than the other drive motor to allow waste transporter 300 to turn. In some embodiments, drive motors 322, 323 are controllable to rotate in either a clockwise or counterclockwise direction to propel waste transporter 300 in either the forward or reverse directions.

Drive system 320 includes drive wheels 325, 326 coupled to drive motors 322, 323 via drive axles 368, 369. Drive axles 368, 369 extend beyond the footprint of carriage 360 such that the wheel base (i.e., the straight-distance between drive wheels 325, 326) of drive system 320 is larger than the width of the carriage. This improves navigation of waste transporter 300 through rough terrain without overturning or disengaging from receptacle 340.

Front wheels 327, 328 are mounted on an underside 370 of bottom panel 362 and positioned to provide stability to waste transporter 300. Front wheels 327, 328 are free to rotate in the motion (i.e., forward and reverse) and turning (i.e., right and left) directions. Therefore, waste transporter 300 is navigated by activating drive motors 322, 323 to propel back wheels 325, 326, and front wheels 327, 328 move freely in response to propulsion forces created by the back wheels. In some embodiments, front wheels 327, 328 can be replaced with casters.

Controller 330 activates drive motors 322, 323 at the same rotational speed or torque, resulting in rotation of drive wheels 325, 326 and subsequent motion of waste transporter 300 along a substantially straight line. Controller 330 may also activate drive motors 322, 323 at different rotational speeds or torques, resulting in rotation of drive wheels 325, 326 at different speeds to turn waste transporter 300. For example, if controller 330 activates drive motor 322 at a faster speed than drive motor 323, waste transporter 300 will turn toward the side of drive motor 323. Conversely, if controller 330 activates drive motor 323 at a faster speed than drive motor 322, waste transporter 300 will turn toward the side of drive motor 322.

To prevent inadvertent turning or spinning of waste transporter 300, controller 330 may be operable to control drive motors 322, 323 (e.g., by controlling speed and/or torque) to transmit approximately identical power to the ground via drive wheels 325, 326. For example, when drive wheel 325 is placed on a slippery surface and drive wheel 326 is placed on dry asphalt, controller 330 may spin drive wheel 325 faster than drive wheel 326 to ensure that the power delivered at each wheel is approximately equal. With equal power delivered at each wheel, waste transporter 300 will continue traveling in a straight line over the slippery surface, thereby avoiding a “spin out.”

Drive wheels 325, 326 may be made of one material while front wheels 327, 328 are made of another material. For example, drive wheels 325, 326 may be air-filled rubber tires to maximize shock absorption while front wheels 327, 328 may be polyurethane to minimize rolling friction.

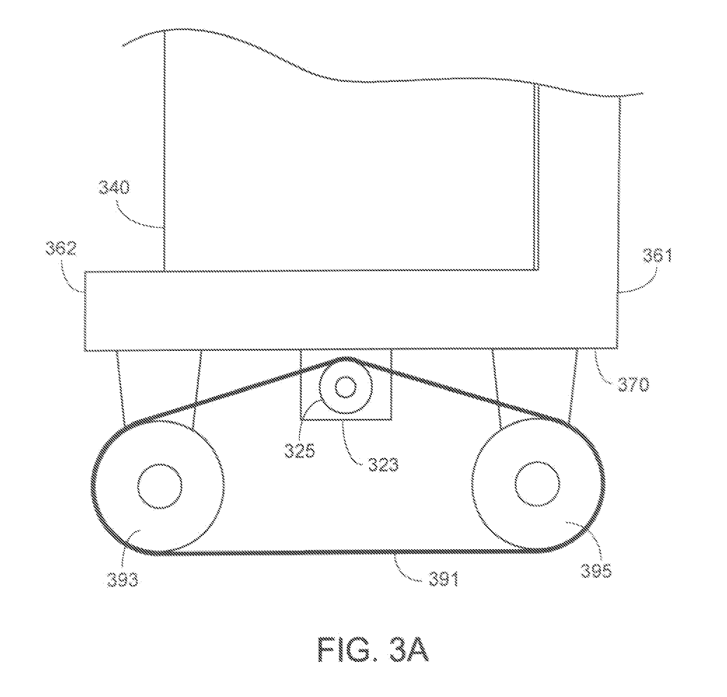

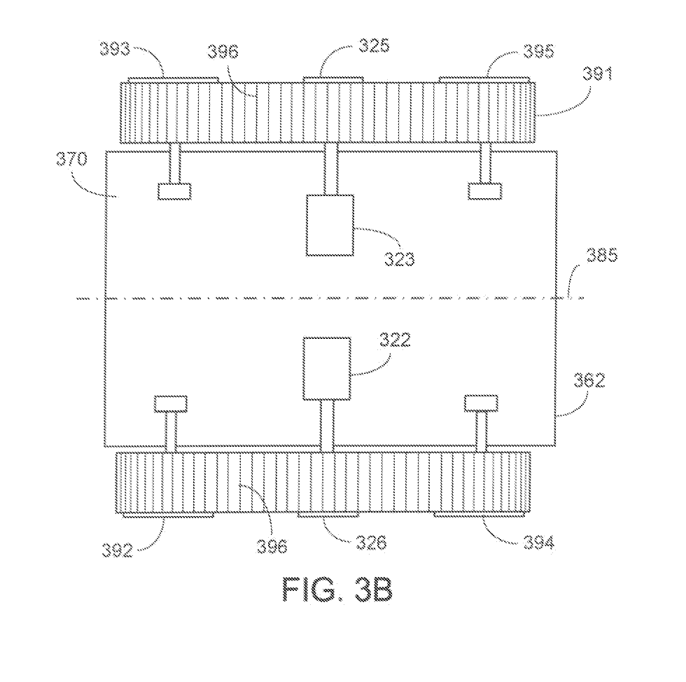

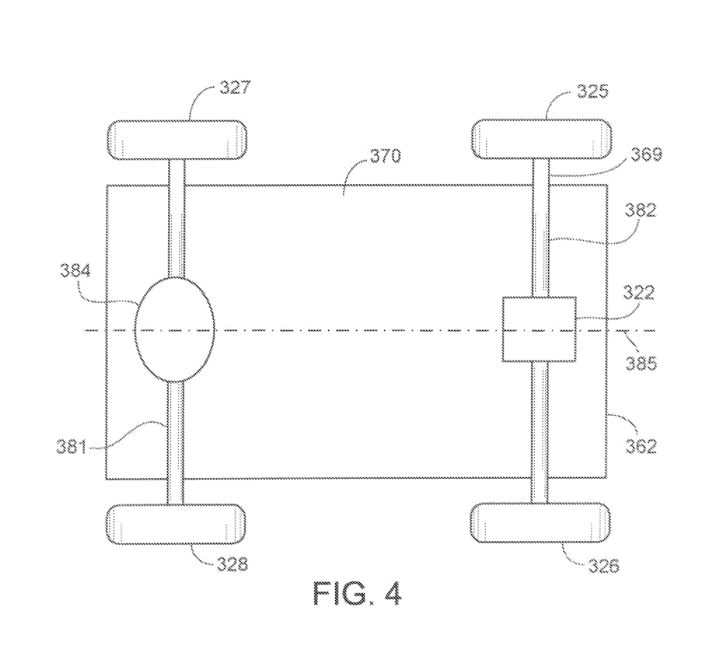

The configuration of drive system 320, and thus the number and arrangement of drive wheels 325, 326 and front wheels 327, 328, may vary. For example, drive system 320 may be configured according to the embodiments illustrated in FIG. 3A and 3B and FIG. 4.

Referring now to FIG. 3A and 3B, drive system 320 includes two rolling tracks 390, 391 positioned on the sides of waste transporter 300 to provide additional stability and maneuverability. Rolling tracks 390, 391 are engaged around drive wheels 325, 326, respectively. As shown in FIG. 3A and 3B, rolling tracks 390, 391 are additionally engaged around front tension wheels 392, 393 and rear tension wheels 394, 395, respectively, such that the rolling tracks are in tension in an approximately triangular shape. In one embodiment, drive wheels 325, 326 include gear teeth to allow improved engagement between the drive wheels and rolling tracks 390, 391. In another embodiment, drive wheels 325, 326 and tension wheels 392-395 may be positioned to maintain rolling tracks 390, 391 in tension and in an approximately oval shape.

Rolling tracks 390, 391 include treads 396 that allow rolling tracks 390, 391 to grip the ground as the rolling tracks move waste transporter 300. In some embodiments, rolling tracks 390, 391 are made of rubber or a similarly pliable material to allow the rolling tracks to flex when the rolling tracks move over obstacles. In other embodiments, rolling tracks 390, 391 are made of steel or a similarly rigid material to minimize wearing or breaking of the rolling tracks.

Drive wheels 325, 326 are directly connected to drive motors 322, 323 respectively. Tension wheels 392-395 are free to rotate but are mechanically coupled to carriage 360 to remain fixed relative to drive wheels 325, 326, thereby ensuring that rolling tracks 390, 391 remain in tension.

In operation, controller 330 activates drive motors 322, 323 to rotate drive wheels 325, 326. Because drive wheels 325, 326 engage rolling tracks 390, 391, respectively, the motion of the drive wheels causes the rolling tracks to move. Waste transporter 300 moves as rolling tracks 390, 391 move and grip the ground.

Controller 330 may drive motors 322, 323 at identical speeds or torques to drive waste transporter 300 in the forward or reverse direction. Likewise, controller 330 may drive motors 322, 323 at different speeds or torques to turn waste transporter to the right or left.

In some embodiments, driving system 320 may include more than two rolling tracks (e.g., two rolling tracks on the right side and two rolling tracks on the left side of waste transporter 300). In other embodiments, driving system 320 may include a single rolling track. In still other embodiments, driving system 320 may include one or more rolling tracks in combination with wheels in contact with the ground. For example, a single rolling track may be arranged to support the rear of carriage 360 and one or more wheels may be arranged to support the front of carriage 360 such that the rolling track propels the waste transporter 300 in the forward and reverse direction and the wheels are arranged to move the waste transporter 300 right or left.

Referring now to FIG. 4, drive system 320 includes front wheels 327, 328 coupled to a common front axle 381. Common front axle 381 is rotatable in a plane parallel to underside 370. In some embodiments, the rotation of common front axle 381 is limited to prevent waste transporter 300 from rolling over.

Common front axle 381 is mechanically coupled to a turning motor 384 operable to turn the common front axle in a plane parallel to underside 370. In operation, controller 330 turns waste transporter 300 in the right or left direction by controlling the position of turning motor 384 and, thus, the position of common front axle 381.

In one embodiment, turning motor 384 is a servo motor with a shaft extending perpendicular to bottom panel 362 and coupled to common front axle 381. In this embodiment, the shaft of the servo motor is controlled to specific angular positions to turn common front axle 381 to a desired degree. Thus, for example, controller 330 may move waste transporter 300 into a slight right turn by activating the servo motor to turn five degrees in the clockwise direction.

In another embodiment, turning motor 384 is a linear actuator mechanically coupled to common axle 381 and oriented to move parallel to centerline 385. The linear actuator is further mounted to the right or left of centerline 385. Because the linear actuator is off-centered with respect to centerline 385, the force of the linear actuator on front axle 381 creates a turning moment on the common front axle, causing the common front axle 381 to turn. Thus, for example, controller 330 may move waste transporter 300 into a slight right turn by activating the linear actuator to move forward ten centimeters.

As shown in FIG. 4, drive wheels 325, 326 are coupled to a common drive axle 382. Common drive axle 382 is mechanically coupled to drive motor 322 such that activation of the drive motor turns the common drive axle to propel waste transporter in the forward or reverse direction.

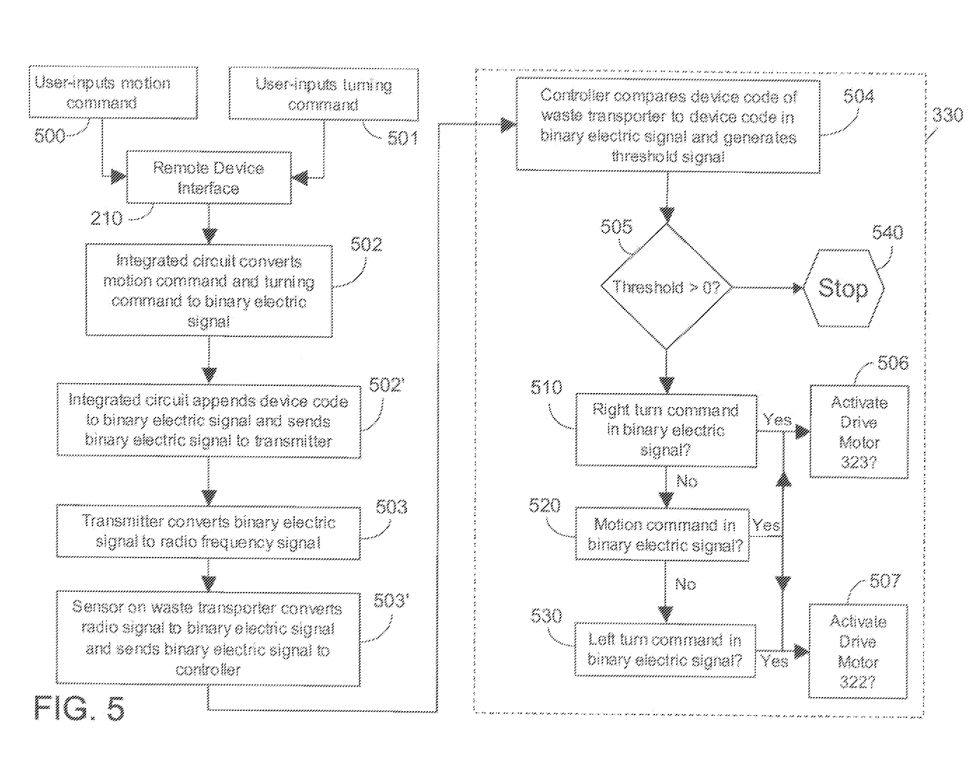

Referring to the control methodology illustrated in FIG. 5, user 1 inputs a motion command 500 and a turning command 501 into remote device 200 via interface 210. Motion command 500 and turning command 501 are then converted to a digital signal 502 through a microcontroller in remote device 200. The microcontroller then appends a device code to digital signal 502 to generate digital signal 502′. Next, the integrated circuit sends digital signal 502′ to transmitter 240, where the transmitter converts the digital signal 502′ to a corresponding radio frequency signal 503. Transmitter 240 broadcasts radio frequency signal 503 into the air at a specific transmission frequency.

Sensor 240 is positioned on waste transporter 300 and is configured to receive radio frequency signals at the transmission frequency used by transmitter 240. Sensor 240 converts radio frequency signal 503 back into digital signal 502′. Sensor 240 then sends digital signal 502′ to controller 330.

Controller 330 compares the device code in digital signal 502′ with the device code of waste transporter 300. Controller 330 generates a threshold signal 504 if the device code in the digital signal 502′ matches the device code of the waste transporter. If threshold signal 504 is greater than zero, controller 330 continues processing the remainder of digital signal 502′, otherwise the controller stops processing the digital signal 502′.

If digital signal 502 includes a forward motion command, controller 330 sends electric signals 506, 507 to activate drive motors 322, 323 respectively in the clockwise direction. If digital signal 502 includes a reverse motion command, controller 330 sends electric signals 506, 507 to activate drive motors 322, 323 respectively in the counterclockwise direction. If digital signal 502 includes a right turn command, controller 330 sends electric signal 506. Conversely, if digital signal 502 includes a left turn command, controller 330 sends electric signal 507.

Controller 330 continues to send electric signals 506 and 507 according to electric binary signal 502 until a new electric binary signal is transmitted by transmitter 240. In some embodiments, motion controller 212 and turning controller 213 are each biased (e.g., using a spring) to return to a “home” position when released by user 1. In this embodiment, the home positions for both motion controller 212 and turning controller 213 represent an “off” command that is transmitted to the integrated circuit and becomes part of the new electric binary signal. Therefore, for example, when user 1 activates motion controller 212, controller 330 receives digital signal 502 corresponding to the motion controller activation and sends electric signals 505 and 506 to activate drive motors 322, 323 until motion controller 212 is returned to its home position. When motion controller 212 returns to its home position, controller 330 receives a new digital signal corresponding to the motion controller deactivation and stops sending electric signals 506 and 507 to activate drive motors 322, 323.

A number of embodiments of the invention have been described. Nevertheless, various modifications may be made.

For example, drive system 320 may include drive wheel 325 configured as a roller with an axial dimension that extends substantially along one dimension of the waste transporter 300, with drive wheel 326 and front wheels 327, 328 omitted. In this embodiment, controller 330 activates drive motor 322 to control the motion of waste transporter 300 in forward and reverse motion only.

The waste receptacle 340 may include a handle (not shown) for manually moving the waste transporter, for example, when the transporter is not operational or needs maintenance or repair.

In other embodiments, transmitter 240 guides waste transporter 300 by detecting a predetermined path. For example, transmitter 240 may be configured to follow a wire, which designates the desired path (e.g., a wire embedded in the ground along the length of a drive way), and waste transporter 300 may move along the desired path by remaining in proximity with signals 2 broadcast from the wire. Thus, there is no need for the user to control or steer the waste transporter as it moves along the predetermined path. Rather, the user, with a single push of a button, can send a signal to activate the waste transporter and send it along its way.

Other embodiments are within the scope of the following claims.

What is claimed is:

1. A waste hauling system comprising:
a receptacle for holding waste;
a drive system for moving the receptacle, said drive system comprising a wheel for moving the receptacle and
a drive motor mechanically coupled to the wheel;
a power source configured to power the drive motor;
a sensor for receiving a signal for operating the drive system; and
a remote device comprising a transmitter for sending the signal received by the sensor.

2. The system of claim 1 wherein the drive system further comprises a plurality of wheels.

3. The system of claim 2 wherein a first and a second of the plurality of wheels are spaced apart.

4. The system of claim 3 further comprising a plurality of drive motors, wherein a first and a second of the plurality of drive motors are coupled to the first and second of the plurality of wheels, respectively.

5. The system of claim 4 wherein the first and second of the plurality of drive motors are operable at different rotational speeds to turn the drive system.

6. The system of claim 5 further comprising a front wheel, wherein the front wheel moves freely in a motion and a turning direction.

7. The system of claim 2 further comprising a front axle coupled to at least one of the plurality of wheels and a turning motor operable to turn the common front axle.

8. The system of claim 7 wherein the turning motor is a servo motor.

9. The system of claim 1 wherein the drive system further comprises a controller operable to control the rotational speed of the drive motor.

10. The system of claim 1 wherein the drive system further comprises a rolling track driven by the wheel.

11. The system of claim 1 further comprising a carriage coupled to the drive system and configured to support the receptacle.

12. The system of claim 11 wherein the receptacle is detachable from the carriage.

13. The system of claim 1 wherein the power source comprises at least one battery.

14. The system of claim 1 wherein the remote device is a hand-held device.

15. The system of claim 1 wherein the remote device further comprises a joystick.

16. The system of claim 1 wherein the remote device further comprises a keypad.

17. The system of claim 1 wherein the remote device further comprises a microcontroller operable to convert instructions from a user into the signal received by the sensor.

18. The system of claim 1 wherein the signal is a wireless signal.

19. The system of claim 18 wherein the wireless signal is a radio frequency signal.

20. The system of claim 1 wherein the transmitter comprises a wire positioned along a desired path of the waste hauling system.

21. A method of transporting waste held in a receptacle comprising: remotely generating a command for moving a drive system coupled to the receptacle; wirelessly transmitting the command to the drive system; and activating a drive motor to move the drive system according to the command.

22. The method of claim 21 further comprising turning the drive system by controlling the rotational speed of each of a plurality of drive motors.

23. The method of claim 21 further comprising turning the drive system by activating a servo motor connected to a common front axle, wherein the common front axle is connected to at least one of a plurality of wheels.
